(19) United States
(12) Patent Application Publication
(10) Pub. No.: US 2008/0053204 A1
(43) Pub. Date: Mar. 6, 2008

(54) Electrochemical Sensor

(76) Inventors: Anne Neville, Moortown (GB); Tong Teh, Edinburgh (GB)

Correspondence Address: RATNERPRESTIA, P O BOX 980, VALLEY FORGE, PA, 19482-0980, US

(21) Appl. No.: 10/581,826

(22) PCT Filed: Dec. 2, 2004
(86) PCT No.: PCT/GB04/05060

§ 371 Date: Aug. 13, 2007

(30) Foreign Application Priority Data
Dec. 2, 2003 (GB) 0327863.7

(51) Int. Cl. G01N 15/06

(52) U.S. Cl. 73/61.71

(57) ABSTRACT

An electrochemical sensor apparatus and method for measuring scale, such as mineral scale or other particulates, which deposit on the surface of pipelines or process equipment. The device has an electrochemical cell with a working electrode and fluid flow control means positioned so as to release a fluid jet onto the working electrode. The velocity of the fluid jet is controllable and is defined by the Reynolds number of the fluid when the fluid is in the fluid flow control means. Measurement of the electrical output from the electrochemical cell and the Reynolds number provide a measure of the build-up of scale on the working electrode.

The present invention relates to an electrochemical sensor apparatus and method and, in particular to an electrochemical sensor that can be used to measure scale, such as mineral scale or other particulates, which deposit on the surface of pipelines or process equipment.

Mineral scale formation is one of the major flow assurance concerns in the chemical industry. The problem of scale build up arises where a fluid is flowing through a pipe or vessel and particulates precipitate out from the fluid and deposit on the surfaces of fluid-carrying equipment. This can cause a blockage to form and to the eventual failure of the equipment or disruption in the flow of the fluid.

This problem is particularly apparent in the offshore oil and gas industry. If the formation of scale or other particulate masses goes uncontrolled, the operational safety of the process or plant equipment can be compromised through the failure of subsea safety and flow control valves or other process equipment. If, for example, a large mass of mineral scale forms in the riser from an oil well, the mass of scale will cause the riser to be blocked, consequently the flow of oil well fluids will be impeded and the pressure will greatly increase, thereby causing the riser to break.

In view of this problem, it is desirable to be able to measure the amount of scale that has formed within a conduit or vessel, and also to be able to estimate and monitor the changes of likelihood that a fluid will precipitate out scale or other particulates. A measurement of the surface deposition on control surfaces or changes of scaling tendency will alert the operator to a build-up of scale. Hence, the operator of the well or chemical process will be able to treat the fluid in order to prevent scaling.

Current methods for monitoring the extent of surface scaling and the scaling tendency in reservoirs or pipes have limitations. They tend to involve measuring water or other fluid samples, or to involve the measurement of flow variables such as pressure. These methods do not allow the operator to predict whether scaling will occur. Scale detection often comes too late using this type of monitoring, typically after a decrease in production. In general, efforts to control the scaling problem have concentrated upon strategies to mechanically or chemically remove scale.

It is an object of the present invention to develop an electrochemical sensor that allows the operator to measure the extent of scale formation on a surface and to assess the scaling tendency of a fluid.

In accordance with a first aspect of the present invention, there is provided an electrochemical sensor comprising:
an electrochemical cell having a sensor means;
fluid flow control means positioned so as to release a fluid jet onto the sensor means, the fluid flow control means having means for controlling the velocity of the fluid jet, the fluid flow velocity being defined by the Reynolds number of the fluid when the fluid is in the fluid flow control means; and
wherein control of the Reynolds number and measurement of the electrical output of the sensor provide a measure of the build-up of scale on the working electrode.

Preferably, the measure of scale build up quantifies the scale build up on the sensor surface in the electrochemical cell.

Preferably, the sensor detects scale build up to measure the scaling tendency of the fluid.

Preferably, the fluid control means is a conduit provided with a control valve or pump.

Preferably, the sensor measures the change in electrical output as a function of Reynolds Number during use of the fluid flow control means

Preferably, the electrical output measurement means measures the limiting current response of the sensor as a function of Reynolds Number.

Preferably, the fluid flow control means is a conduit having a predefined diameter (d) and is positioned at a height (H) above the sensor having a radius (r).

Preferably, laminar flow of the fluid from the fluid control means is provided by setting said diameter (d), height (H) and radius (r).

Preferably, H/d=1; and r/d<0.5.

Preferably, the apparatus of the present invention further comprises fluid sampling means for obtaining a sample of a test fluid.

Preferably, the fluid sampling means contains fluid isolation means for isolating the test fluid from a bulk fluid.

Preferably, the test fluid isolation means is provided by a container having at least one sealable valve which, when opened, allows the test fluid to enter the sampling means.

Preferably, the fluid flow control means comprises a flow meter or flow sensor for measuring flow, connected to a conduit from which said fluid jet is expelled.

Preferably, the sensor comprises a working electrode, a counting electrode and a reference electrode.

Preferably, the electrochemical sensor further comprises a reservoir for storing a second, pre-prepared electrolyte, flow control means and one or more conduits connected to the electrical cell such that the pre-prepared electrolyte is used with the electrical cell to measure the quantity of scale deposited by the test fluid by measuring the electrical output of the cell as a function of Reynolds Number.

In some examples of the present invention it has been found that quantitative measurement of the extent of scaling is more accurately determined by replacing the test fluid with said pre prepared electrolyte in order to make measurements.

Preferably, the electrolyte is a solution. Preferably, the electrolyte is a solution of brine containing a suitable tracer.

Preferably, the tracer is oxygen.

Optionally, the tracer is an ion tracer.

Optionally, the tracer is

$${Fe ( CN )}_{6}^{4 -} .$$

Preferably, the pre-prepared solution has a saturation ratio of less than 1.

Optionally, the pre-prepared solution has a saturation ratio of greater than 1.

In accordance with a second aspect of the present invention, there is provided a method of measuring the scaling properties of a test fluid, the method comprising the steps of:
controlling the velocity of a fluid jet as defined by the Reynolds number of the fluid when the fluid is in a fluid flow control means;
releasing the fluid jet from the fluid control means onto a sensor of an electrochemical cell; and
measuring the electrical output from the sensor as a function of the Reynolds number of the jet fluid, the sensor being in contact with a sample of the test fluid.

Preferably, the sensor gives a measure of the change in electrical output as a function of Reynolds number during use of the fluid flow control means.

Preferably, the electrical output provides a measure of the limiting current response of the electrochemical cell as a function of Reynolds Number.

Preferably, the fluid flow control means is a conduit having a predefined diameter (d) and is positioned at a height (H) above the working electrode or sensor having a radius (r).

Preferably, laminar flow of the fluid from the fluid control means is provided by setting said diameter (d), height (H) and radius (r).

Preferably, H/d=1; and r/d<0.5.

Preferably, the test fluid has a saturation ratio of greater than 1.

Preferably, the pre-prepared electrolyte is a conductive Brine solution containing an oxygen tracer.

Optionally, the method comprises the further step of isolating the test fluid from a flowing fluid prior to measuring the electrical output from the electrical cell as a function of the Reynolds number of the fluid.

Preferably, the test fluid is isolated by closing valves arranged upstream and downstream of a predetermined measuring location in a sample measuring means.

It has been found that isolation of a sample of the fluid allows the fluid velocity as defined ny the Reynolds Number to be carefully controlled in the sensor device.

Preferably the fluid is isolated by removably attaching a sampling conduit to a first conduit in which the bulk of the fluid is situated, and by providing valves to isolate the sampling conduit from the first conduit.

In accordance with a third aspect of the present invention there is provided a method of measuring the scaling properties of a test fluid, the method comprising the steps of:
introducing a jet of test fluid into an electrochemical cell so as to allow scale to build up on one or more surfaces in the cell;
removing the test fluid from the electrochemical cell;
introducing a pre-prepared solution into the cell; and measuring the electrical output from the electrochemical cell.

Preferably, the test fluid is introduced into the electrochemical cell at a rate defined by the Reynolds Number of the fluid when contained in a first fluid control means.

Preferably, the pre-prepared solution is introduced into the electrochemical cell at a rate defined by the Reynolds Number of the fluid when contained in a second fluid control means.

Preferably, the electrical output measures the change in electrical output as a function of Reynolds Number during use of the fluid flow control means.

Preferably, the electrical output provides a measure of the limiting current response of the electrochemical cell as a function of Reynolds Number.

Preferably, the fluid flow control means is a conduit having a predefined diameter (d) and is positioned at a height (H) above the working electrode or sensor having a radius (r).

Preferably, laminar flow of the fluid from the fluid control means is provided by setting said diameter (d), height (H) and radius (r).

Preferably, H/d=1; and r/d<0.5.

Preferably, the pre-prepared solution has a saturation ratio of less than 1.

Optionally, the pre-prepared solution has a saturation ratio of greater than 1.

In accordance with a fourth aspect of the present invention, there is provided a computer program for use with apparatus of the first aspect of the present invention, and with the method of the second aspect of the present invention, in which analysis of the electrical output and the Reynolds number provides information on the quantity of scale build up and/or the scaling tendency of the fluid.

The present invention will now be described by way of example only, with reference to the accompanying drawings, in which:

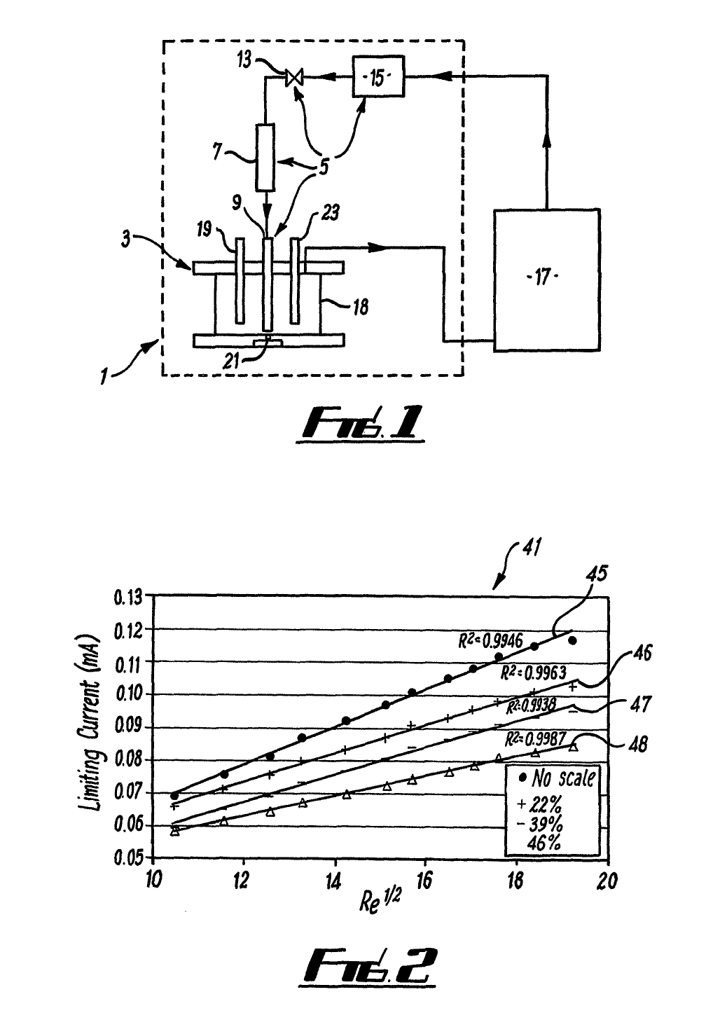

FIG. 1 is a schematic diagram of an embodiment of the apparatus of the present invention;

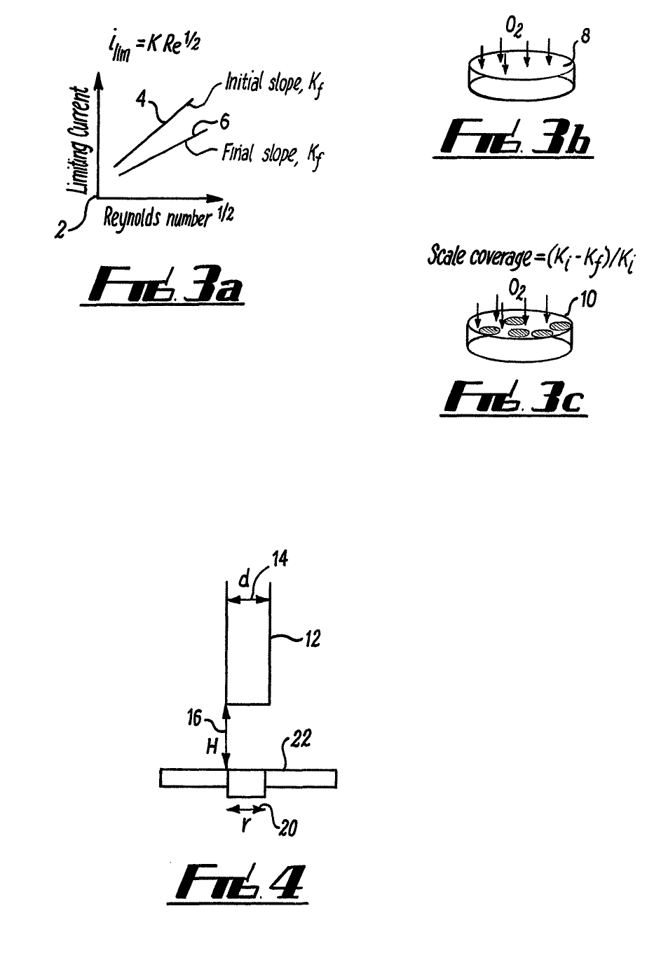

FIG. 2 is a graph of the limiting current output of the electrochemical cell, as measured against the square root of the Reynolds Number of the jet fluid;

FIG. 3a is a graph of limiting current v Reynolds number which shows it's variation after scaling has occurred, FIGS. 3b and 3c illustrate physical change to the sensor before and after scaling;

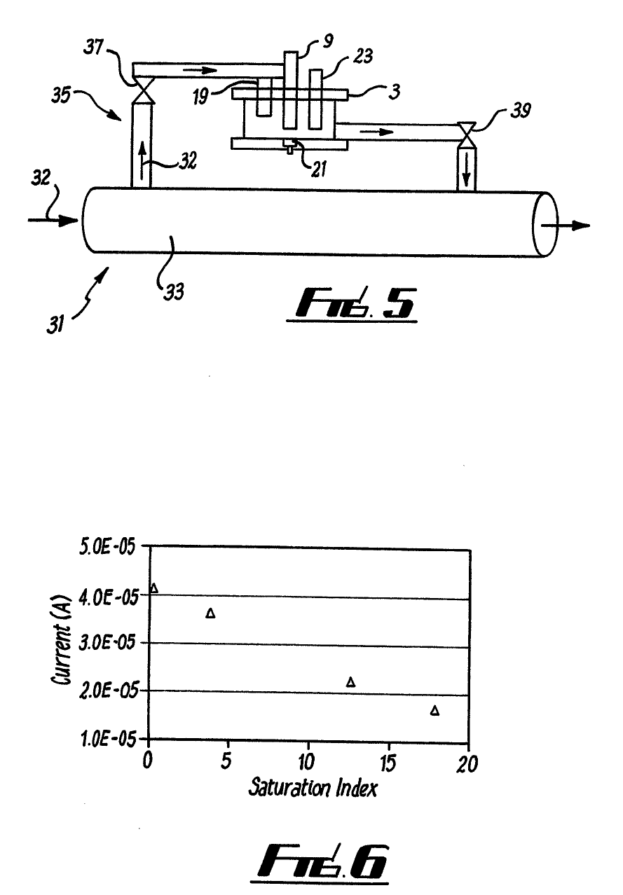

FIG. 4 shows the relationship between the nozzle 12 from which the impinging jet emanates and the sensor 22

FIG. 5 is a schematic representation of the second embodiment of the present invention, where the electrochemical cell is positioned in a conduit, removably connected to a riser;

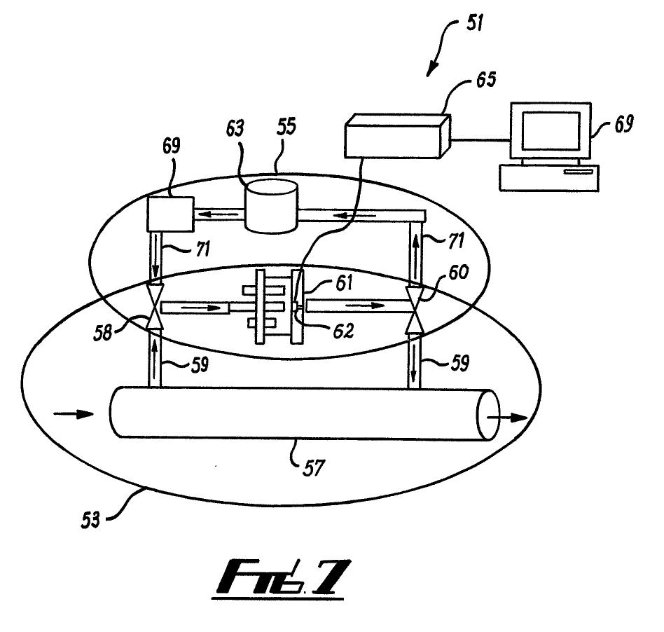

FIG. 6 shows the limiting current correlation with scaling index of the water;

FIG. 7 is a schematic diagram of a third embodiment of the present invention;

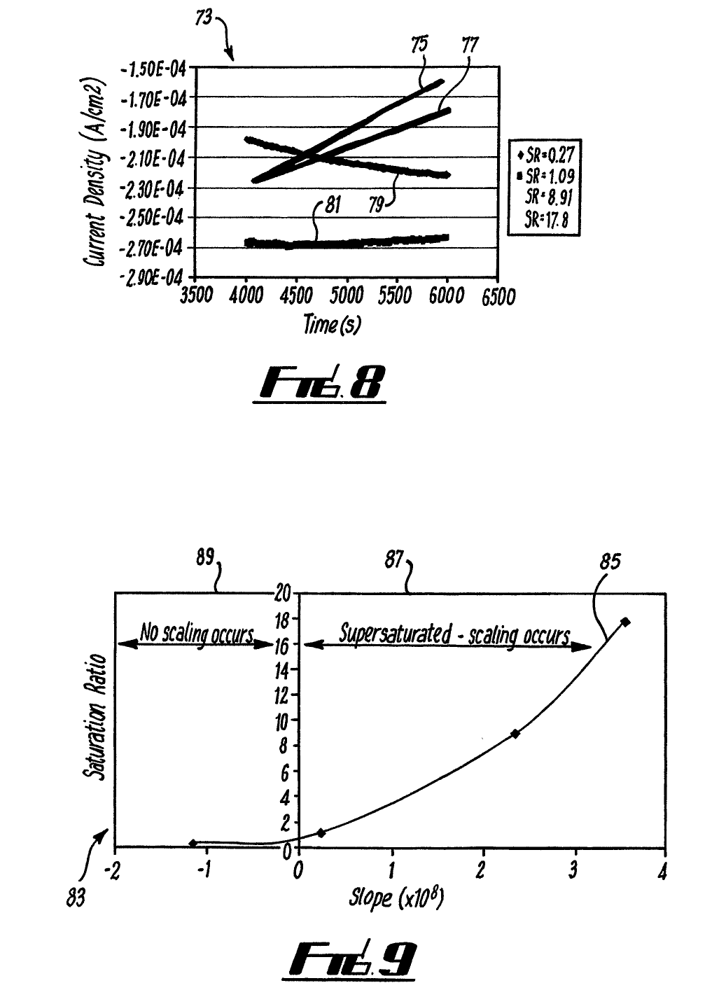

FIG. 8 is a graph showing the current response to pre-prepared brine solutions having different saturation ratios; and

FIG. 9 is a graph showing the correlation between the saturation ratio for sample solutions and the slope of the current similar to that of FIG. 8.

FIG. 1 shows an electrochemical sensor setup comprising an electrochemical cell rig 3, having the following components. The electrochemical cell rig 3 comprises a sensor (working electrode) 21 position proximate and normal to the nozzle 9 through which a fluid jet (also known as an impinging jet) exits from the nozzle 9. In addition, the cell rig 18 provides support for a reference electrode (silver-silver electrode) 19 and a counting electrode 23 made of platinum, in this example.

The fluid control means consists of a pump 15 positioned downstream of a needle valve 13 which is used to control the flow level of the impinging jet fluid. A flow meter 7 is used to measure the amount of flow of the impinging jet fluid so as to allow calculation of the Reynolds number of the jet fluid. A nozzle 9 provides the means by which the impinging jet fluid exits the fluid control means 5 and contacts the working electrode 21. In this example, a solution tank is provided for storage and circulation of the impinging jet fluid.

FIG. 2 is a graph of the limiting current i_{L} measured against the square root of Reynolds Number (Rₑ^{1/2}). The graph 41 shows three curves. The first curve illustrates a situation in which no scale has been deposited upon the working electrode from the test fluid. Curve 45 illustrates the situation on an unscaled sensor. Curves 46, 47 and 48 illustrate the response from the sensor with 22%, 39% and 46% of scale coverage respectively after immersion for 1, 9 and 24 hours in a scaling solution. These schematic representations show the difference in the limiting current over the same range of Reynolds number, where the level of scaling in the sample is different.

| Immersion | % Scale |
|---|---|
| Time, Hrs | Coverage |
| 1 | 22 |
| 9 | 39 |
| 24 | 46 |

Table 1 shows the resultant scale coverage for different immersion times.

In use, the fluid control means or impinging jet system 5 is submerged in a fluid sample, and is used to control the hydrodynamic regime at the surface of the working electrode 21. Through analysis of the oxygen tracer reduction reaction on the sensor surface, the extent of scaling and the scaling tendency of the fluid can be determined. In this example the test solution has a saturation ratio of greater than 1 and is used to deposit scale on the sensor surface. A pre-prepared electrolyte is used to determine the scale coverage.

The potential of the electrochemical sensor 1 is applied to −0.8 volts (with respect to a silver/silver chloride system) when measurements are started. The impinging jet system is then controlled through a range of Reynolds numbers, and the limiting current response is measured as a function of the Reynolds number. Measuring the relationship between these two variables, enables scaling information to be obtained. In this way, the amount of scale and the scaling tendency of the test fluid can be determined.

FIG. 6 shows the limiting current correlation with scaling index (log of saturation ratio) of the test fluid (water containing electrolyte) for 6000s. The correlation between the scaling index and the electrochemical measurement make it possible to measure the scaling tendency of a fluid.

FIGS. 3 a to c and 4 provide more detailed explanation of a sensor in accordance with the present invention.

FIG. 3a is a graph 2 of limiting current versus Reynolds Number^{1/2} on a sensor. Two curves 4 and 6 illustrate the change in limiting current as a function of Reynolds number from initial values (curve 4) to final values (curve 6).

FIG. 3b shows the sensor surface 8 before the use of the impinging jet which emanates from the nozzle, and

FIG. 3c shows the sensor surface after this operation.

The surface can be seen to be patchy as a result of scale coverage.

Limiting current is given as follows:

Iₗᵢₘ=K Re^{1/2}

The a measure of the scale coverage on the sensor is given by:

Scale coverage=(Kᵢ-K_{f})/Kᵢ

FIG. 4 shows the relationship between the nozzle 12 from which the impinging jet emanates and the sensor 22 The nozzle has an inner diameter d 14 and the nozzle is placed at a distance H 16 from the sensor 22. Laminar flow of the surface impinging jet occurs where:
H/d=1; and
r/d<0.5.

FIG. 5 shows a second embodiment of the present invention, in which the cell rig is installed in the bypass system of a sub-sea pipeline. The arrows 32 show the direction of fluid flow through the system. The fluid flow rate as quantified by calculation of the Reynolds number is controlled through valves 37, 39 located in the inlet and outlet of the bypass.

As shown in FIG. 5, the bulk fluid 33 flows down conduit 31 and a sample (the test fluid) of the bulk fluid 33 is tapped from the bulk fluid conduit 31 to measurement conduit or bypass system 35. Once the test fluid has been tapped, valves 37 and 39 are used to control the fluid flow rate into the cell 3 where scale is deposited on the working electrode 21. The working electrode (sensor) 21 is connected to a potentiostat (not shown)A flow meter (not shown) measures the flow rate. In this example, to enable measurements of the extent of scale to be made, the impinging jet is directed onto the working electrode 21 and the fluid surrounding the sensor is essentially static.

The output current from the electrochemical cell 3 over a period of time enables the scaling tendency to be measured. Accordingly, the likelihood and speed with which scale is likely to precipitate out from the bulk fluid can be estimated.

The ability to operate the electrochemical sensor of the present invention in situ allows the scaling tendency to be monitored as the pressure, temperature, water chemistry and other environmental conditions change. By locating the apparatus of the present invention within the precise zone of interest within a pipeline, the present invention can monitor the scaling tendency from individual branches of a pipe in, for example, a horizontal well which goes into the main pipeline. Information feedback from the well can provide an early indication of scaling potential problems. Hence, the present invention enables the operator to manage and selectively control individual wells and to inject the correct amount of scale inhibitor in these wells.

Further advantageously, the present invention can detect small amounts of scale and can rapidly (within a matter of 30 minutes or so) determine the scaling tendency of the sample. As a consequence, the operator of the conduit, whether it be a riser from an oil well, a subsea pipeline, a pipe in a desalination plant, or otherwise, can quickly determine the scaling tendency in these positions and can anticipate problems associated with the build up of scale.

In use, the apparatus of the present invention will be connected to an operator terminal by means of a suitable telemetry system. This will allow data to be collected frequently by the operator using a communications protocol. Real-time data from the oil well or other location will be sent to a PC based surface system that monitors this location. In addition, multiple systems can be used at varying locations in a pipeline system or well or the like, and all of these individual systems can feed data back to a single PC for analysis by the operator, who may then use this data to determine it is necessary to add chemical scale inhibitors to that location, or to otherwise remove or limit the scale measured at that location.

FIG. 7 shows a further embodiment of the present invention similar to that shown in FIG. 7. FIG. 7 is an embodiment of the invention in which a pre-prepared solution is used when measuring the scale coverage of a working electrode. The sensor arrangement 51 has two fluid flow paths 53 and 55.

Flow path 53 is similar to the flow path shown in FIG. 7 and allows a fluid sample to be taken from a pipe 57 and fed through an electrochemical cell 61 via a conduit 59. Flow path 55 includes a solution tank 63 and a pump 69 which allow the supply of a pre-prepared electrolyte (brine in this example) to the electrochemical cell rig. It has been found that the use of this electrolyte allows a more accurate measure of the scale coverage to be achieved as the electrolyte is pre-prepared and substantially free from the contaminants that are often found in the bulk fluid contained in the pipeline 57.

A potentiostat 65 is used to measure the electrical output of the electrochemical cell and this is connected to a personal computer or network 69 by means of a suitable connection. This allows the end user to monitor the scale coverage or scaling tendency from an office or lab.

In order to measure scale coverage using this example of the present invention, test fluid from the pipeline 57 is fed into the electrochemical cell 61 via the conduit 59 and the control valve 58 such that the test fluid continuously impinges upon the sensor surface 62. Valves 58 and 60 are used to control the rate at which the which test fluid enters the cell, the flow is measured by a flow meter (not shown) from which the Reynolds number can be calculated. At this stage, the electrical output of the cell 61 is not measured however, as the rate of test fluid entry into the cell is a variable in the system, it is desirable to control and measure this variable as it shows the extent to which the flow is laminar or turbulent. The test fluid flow is controlled so that it continuously impinges upon the sensor surface 62 (working electrode) for a predetermined period of time and scale is deposited onto the sensor surface 62.

The extent of scale on the surface 62 is measured using the pre-prepared electrolyte (typically an electrolytic solution such as brine) and is provided to the cell 61 via flow path 55. The brine solution is pumped continuously through the cell 61 in a controlled manner such that the Reynolds Number of the flowing brine can be measured. The scale coverage of the sensor 62 is measured using the potentiostat 65 to record the output current of the cell 61.

In this example of the present invention, the scaling tendency of the test fluid is measured as follows. Test fluid from the pipeline 57 is fed into the electrochemical cell 61 via the conduit 59 and the control valve 58 such that the test fluid continuously impinges upon the sensor surface 62. Valves 58 and 60 are used to control the rate at which the test fluid enters the cell. The Reynolds Number can therefore be calculated.

The current output of the cell 61 is measured as a function of time and the scaling tendency can be calculated and provided to a user through the PC or network 69.

FIG. 8 is a graph 73 showing the current response (current density) as a function of time for electrolytic solutions (brine) having different saturation ratios. The saturation ratios for curves 75, 77, 79 and 81 are 17.8, 8.91, 0.27 and 1.09 respectively. Curve 79 has a negative gradient.

FIG. 9 is a graph 83 which illustrates the correlation between saturation ratio and the slope of the current values against time as exemplified in FIG. 8. Curve 85 shows that scaling of the fluid does not occur in region 89 where the saturation ratio is below approximately 1 and scaling does occur in region 87 of the graph 83 where the scaling ratio is above approximately 1. This region is where the fluid is supersaturated.

The present invention has a number of advantages over the known prior art. In particular, the present invention allows early measurement of scale or other particulates, and provides a means by which the scaling tendency of the fluid in question can be measured. Measurement of the scaling tendency, as well as the bulk amount of scale, allows the operator to predict the amount of inhibitor that should be used, and also to predict when in the future this inhibitor should be applied. Improvements and modifications may be incorporated herein, without deviating from the scope of the invention.

1. An electrochemical sensor comprising:
an electrochemical cell having a sensor and an electrical output;
fluid flow control means positioned so as to release a fluid jet of a fluid from inside the fluid flow control means onto the sensor means, the fluid jet having a fluid flow velocity, the fluid flow control means having means for controlling the velocity of the fluid jet, the fluid flow velocity being defined by the Reynolds number of the fluid when the fluid is in the fluid flow control means; and
wherein control of the Reynolds number and measurement of the electrical output of the electrochemical cell provide a measure of the build-up of scale on the sensor.

2. An electrochemical sensor as claimed in claim 1 wherein the sensor has a sensor surface and the measure of scale build up quantifies the scale build up on the sensor surface in the electrochemical cell.

3. An electrochemical sensor as claimed in claim 1 wherein, the sensor detects scale build up to measure the scaling tendency of the fluid.

4. An electrochemical sensor as claimed in claim 1 wherein, the fluid control means is a conduit provided with a control valve or a pump.

5. An electrochemical sensor as claimed in claim 1 further comprising an electrical output measurement means wherein, the electrical output measurement means measures the change in electrical output as a function of Reynolds Number during use of the fluid flow control means.

6. An electrochemical sensor as claimed in claim 5 wherein the sensor responds to limiting current and the electrical output measurement means measures the limiting current response of the sensor as a function of Reynolds Number.

7. An electrochemical sensor as claimed in claim 1, wherein the fluid flow control means is a conduit having a predefined diameter (d) and is positioned at a height (H) above the sensor having a radius (r).

8. An electrochemical sensor as claimed in claim 7 wherein laminar flow of the fluid from the fluid control means is provided by setting said diameter (d), height (H) and radius (r).

9. An electrochemical sensor as claimed in claim 7 wherein H/d=1; and r/d<0.5.

10. An electrochemical sensor as claimed in claim 1 further comprising fluid sampling means for obtaining a sample of a test fluid.

11. An electrochemical sensor as claimed in claim 10 wherein, the fluid sampling means contains fluid isolation means for isolating the test fluid from a bulk fluid.

12. An electrochemical sensor as claimed in claim 11 wherein, the fluid isolation means includes a container having at least one sealable valve which, when opened, allows the test fluid to enter the fluid sampling means.

13. An electrochemical sensor as claimed in wherein, the fluid flow control means comprises a flow meter or flow sensor for measuring flow, connected to a conduit from which said fluid jet is released.

14. An electrochemical sensor as claimed in claim 1 wherein, the sensor comprises a working electrode, a counting electrode and a reference electrode.

15. An electrochemical sensor as claimed in claim 1 wherein, the electrochemical sensor further comprises a reservoir for storing a electrolyte, flow control means and one or more conduits connected to the electrochemical cell such that the electrolyte is used with the electrochemical cell to measure the quantity of scale deposited by a test fluid by measuring the electrical output of the electrochemical cell as a function of Reynolds number.

16. An electrochemical sensor as claimed in claim 15, wherein the electrolyte is a solution.

17. An electrochemical sensor as claimed in claim 15 wherein, the electrolyte is a solution of brine containing a suitable tracer.

18. An electrochemical sensor as claimed in claim 17 wherein the tracer is ionic.

19. An electrochemical sensor as claimed in claim 17 wherein the tracer is oxygen.

20. An electrochemical sensor as claimed in claim 15 wherein, the electrolyte has a saturation ratio of less than 1.

21. An electrochemical sensor as claimed in claim 15 wherein, the electrolyte has a saturation ratio of greater than 1.

22. A method of measuring the scaling properties of a test fluid, the method comprising the steps of:
controlling a velocity of a fluid jet of a fluid as defined by the Reynolds number of the fluid when the fluid is in a fluid flow control means;
releasing the fluid jet from the fluid control means onto a sensor of an electrochemical cell; and
measuring the electrical output from the electrochemical cell as a function of the Reynolds number of the fluid, the sensor being in contact with a sample of the test fluid.

23. The method of claim 20 wherein, the electrochemical cell has a sensor and the electrochemical cell gives a measure of the change in electrical output as a function of Reynolds number during use of the fluid flow control means.

24. The method of claim 22 wherein, the electrical output provides a measure of the limiting current response of the electrochemical cell as a function of Reynolds Number.

25. The method of claim 22, wherein the fluid flow control means is a conduit having a predefined diameter (d) and is positioned at a height (H) above the sensor having a radius (r).

26. The method of claim 25, wherein laminar flow of the fluid from the fluid control means is provided by setting said diameter (d), height (H) and radius (r).

27. The method of claim 25 wherein H/d=1 and r/d<0.5.

28. A method as claimed in claim 22 comprising the further step of isolating the test fluid from a flowing fluid prior to measuring the electrical output from the electrochemical cell as a function of the Reynolds number of the fluid.

29. A method as claimed in claim 28 wherein, the test fluid is isolated by closing valves arranged upstream and downstream of a predetermined measuring location in a sample measuring means.

30. A method as claimed in claim 22 wherein the fluid is isolated by removably attaching a sampling conduit to a first conduit in which a bulk of the fluid is situated, and by providing valves to isolate the sampling conduit from the first conduit.

31. A method of measuring the scaling properties of a test fluid, the method comprising the steps of:
introducing a jet of test fluid into an electrochemical cell so as to allow scale to build up on one or more surfaces in the electrochemical cell;
removing the test fluid from the electrochemical cell;
introducing a pre-prepared solution into the electrochemical cell; and
measuring the electrical output from the electrochemical cell.

32. A method as claimed in claim 31 wherein, the test fluid is introduced into the electrochemical cell at a rate defined by the Reynolds Number of the fluid when contained in a first fluid control means.

33. A method as claimed in claim 32 wherein, the pre-prepared solution is introduced into the electrochemical cell at a rate defined by the Reynolds number of the fluid when contained in a second fluid control means.

34. The method of claim 31 wherein, the electrical output measures a change in electrical output as a function of Reynolds Number during use of a fluid flow control means.

35. The method of claim 31 wherein, the electrical output provides a measure of the limiting current response of the electrochemical cell as a function of Reynolds Number.

36. The method of claim 34, wherein the fluid flow control means is a conduit having a predefined diameter (d) and is positioned at a height (H) above a sensor having a radius (r).

37. The method of claim 36, wherein laminar flow of the fluid from the fluid control means is provided by setting said diameter (d), height (H) and radius (r).

38. The method of claim 36 wherein H/d=1 and r/d<0.5.

39. A method as claimed in claim 31 wherein, the pre-prepared solution has a saturation ratio of less than 1.

40. A method as claimed in claim 31 wherein, the pre-prepared solution has a saturation ratio of greater than 1.
